(19) United States
(12) Patent Application Publication
(10) Pub. No.: US 2019/0394079 A1
(43) Pub. Date: Dec. 26, 2019

(54) PROCEDURE FOR MANAGING A FAILURE IN A NETWORK OF NODES BASED ON A GLOBAL STRATEGY

(71) Applicant: BULL SAS, Les Clayes Sous Bois (FR)

(72) Inventors: Guillaume LEPOUTERE, GRENOBLE (FR); Emmanuel BRELLE, GRENOBLE (FR); Florent GERMAIN, LE PONT DE CLAIX (FR); Piotr LESNICKI, GRENOBLE (FR)

(21) Appl. No.: 16/448,946

(22) Filed: Jun. 21, 2019

(30) Foreign Application Priority Data
Jun. 22, 2018 (FR) 18 55558

(51) Int. Cl. H04L 12/24; G06F 11/07

(52) U.S. Cl. CPC H04L 41/069; H04L 41/0668; G06F 11/0784; H04L 41/0659

(57) ABSTRACT

Disclosed is a failure management method in a network of nodes, including, for each node considered within all or part of the nodes of the network performing the same calculation: firstly, a step of locally saving the state of this considered node to a storage medium for this considered node, the link between this node storage medium and this considered node can be redirected from this storage medium to another node, then, if the considered node is faulty, a step of retrieving the local backup of the state of this considered node, by redirecting the link between the considered node and its storage medium in order to connect the storage medium to an operational node different from the considered node, the local backups of these considered nodes used for the retrieving steps being coherent with each other to correspond to the same state for this calculation.

### FIELD OF THE INVENTION

The invention relates to methods for managing failures in a node network and node network sections associated with this failure management.

### BACKGROUND OF THE INVENTION

In a network of nodes performing the same calculation, backups are performed at one or more levels. Therefore, these are multilevel backups. When a failure occurs, the calculation can be retrieved at least partially without requiring a complete restart, quite simply thanks to the backups made. Depending on the type of failure, a certain level of backup is used to retrieve the calculation in part or even in terms of the majority or almost completely.

Distributed applications can last much longer than average, without any network failure, also called MTBF of a cluster (“Mean Time Between Failures”), so they are many opportunities for interruption. In general, they do not have an internal failure-management solution, which can then lead to the loss of local backup data in the event of a physical failure of the compute node. This is then followed by the loss of all the calculation steps caused by the loss of a single compute node but whose local backup data can no longer be retrieved.

There are backup and retrieving solutions known as “checkpoint/restart” solutions from backups, allowing applications to regularly save their context on different levels of backup according to at different speeds.

The different backup levels range from very local to very global, from the simplest and fastest to the most complex, slowest, and most expensive, the least robust and weakest to the most robust and resilient backup.

A previous method, according to the FTI library (“Fault Tolerance Interface”) states that there are four known levels of backup, which are:
The first level, L1, which carries out a local backup. This is simple and inexpensive and performed very often, resulting in the minimal loss of computation time during a failure and with retrieving ability at this first level, L1,
The second level, L2, which performs a first intermediate backup by duplication on a partner node, is less simple and a little more expensive, resulting in a greater loss of computation time during a failure, with retrieving only possible at this second level, L2,
The third level, L3, which makes a second intermediate save Reed-Solomon encoding, is even less simple and still a little more expensive, resulting in an even greater loss of computing time during a failure and recoverable only at this third level, L3,
The fourth level, L4, which performs a global backup in terms of the file system is complex and quite expensive, resulting in a really significant loss of computing time during a failure, with retrieving only possible at this fourth level, L4.

From the local level, L1, to the global level, L4, the backup becomes more and more robust and resilient, but it also becomes more and more complex and expensive. For this reason, a backup at the first level, L1, is often performed, a backup at the second level, L2, is performed a little less often, a backup at the third level, L3, less often still and a backup of the fourth level, L4, is relatively rare. Therefore, statistically, when a failure occurs, the last coherent state that can be retrieved is very recent at the first level, L1, a little less recent at the second level, L2, less recent still at the third level, L3, and even older at the fourth level, L4. Consequently, the volume of work lost is very small at the first level, L1, relatively limited at the second level, L2, notable at the third level, L3, and greater at the fourth level, L4.

### SUMMARY OF THE INVENTION

The object of this invention is to provide a means of failure management in a node network by at least partially overcoming the aforementioned drawbacks.

More particularly, the invention aims to provide a means of failure management in a network of nodes by improving the compromise between efficiency on the one hand and cost and complexity on the other hand, for at least one level of backup considered.

More particularly, the aim of the invention is to provide a means of failure management in a network of nodes with an efficiency similar or comparable to that of an intermediate-level backup, preferably the first intermediate backup, the second level, L2, being more advantageous in terms of the cost and complexity being similar or comparable to those of a local level backup, preferably those within the first level, L1.

To achieve this, the invention proposes to create a link between a storage medium and its redirection node to another node, so the backup is made on the storage medium when the node is defective, possibly by making a a copy on a neighboring node, but without the backup copy on this neighboring node being for the majority or all of the nodes that have not failed, at least not before any failure has occurred. The link between a storage medium and its node is not carried out directly, but indirectly through a network element able to reconfigure this link in order to link this storage medium to another node when the previous node becomes failing. This network element links several nodes to their respective storage media, each node being connected to its associated storage medium (or possibly to its associated storage media).

In summary, a backup is available for failing nodes despite the failure of these node, resulting in a similar efficiency level as for the second level, L2, but without a more complex operation than a simple local backup for the majority or all of the nodes which are not failing, which is the majority or even the greater majority of the nodes in the network that carry out the calculations under consideration, with a cost and a complexity at least comparable if not similar to those of the first level, L1, and, in any case, not until there is a breakdown.

Thus, according to methods of implementation for the invention, the cost of the second level, L2, is saved, while the ability to restart an application from the backups at the first level, L1, is maintained in the event of a failure in a compute node. The copy to a neighboring node traditionally performed at the second level, L2, is not carried out here during the execution of the application in preventive terms for all the compute nodes, but only in the case of a breakdown and only for the nodes that are failing after the breakdown has happened. The copy is only then made to relaunch the application with the missing data, with uploads from the local backup.

On the one hand, this backup has a cost and complexity similar or comparable to a local backup has the effectiveness of an intermediate backup, which greatly improves its value for money.

On the other hand, this backup is of a cost and complexity similar to or comparable to a local backup with the efficiency of an intermediate backup, preferably enables the replacement of both a conventional local backup and one or more conventional intermediate backups, by not keeping anything other than the global backup as a last resort to handle the most severe failures. Most of the failures can now be managed by the local-intermediate backup proposed by the invention, the latter being as effective as an intermediate backup but practically at the cost of a local backup.

This backup provided by the invention is the optimal compromise between efficiency and complexity and is used according to a global strategy. In this global strategy, the link redirection mechanism between calculation nodes and their associated memory is used to retrieve the backup of a failed node and integrate it into a global backup so the resource manager can start a new task.

In this way, the synchronizations between nodes, especially when these are numerous, is better managed than in a more local strategy, thanks to the geographical proximity of the nodes to be synchronized, guaranteed, in particular, through the preferential scheduling of a new task to relaunch the calculation.

Thus, any risk of delay between nodes to be synchronized can be avoided, because these chosen nodes to be synchronized will not be physically too distant (which could be the case if a failing node was replaced by a distant node, which then had to significantly communicate with a neighboring node to the defective node), avoiding, at the same time the risk of associated delay for the entire calculation to be performed.

A more local strategy would use the link redirection mechanism between compute nodes and associated memory to retrieve the backup of a failing node and attach it to a new node added for the event during the same task, the non-failing nodes, and preferably also nodes not integrated with a compute blade including failed node, being retained and relaunched from their own local backup.

For this purpose, this invention proposes a failure management method in a nodes network, comprising, for each considered node of all or part of the nodes of the network performing a same calculation: first, a local backup step for the node considered in terms of a storage medium for this node, where the link between this storage medium and this node can be redirected from the storage medium to another node, then, if the considered node fails, there can be a local backup retrieving step for the considered node, by redirecting the link between the considered node and its storage medium to connect the storage medium to an operational node that is different from the considered node. Since this operational node is already performing the said calculation, the local backups of these considered nodes, used for the retrieving steps, are coherent with each other to correspond to the same state of this calculation, and then, if at least one considered node has failed, the return step from the local backup to a global backup at a file system level within the network can be carried out.

Preferably, the failure management method comprises the following: after the return step, a relauching step for the calculation from the global backup integrating the local backups, by the network resource manager scheduling a new task using all or part of the nodes that have already participated in the calculation and/or nodes that have not yet participated in this.

More generally, the invention makes the link between a storage medium and its redirection node to another node, so the backup is performed on the storage medium when the node is failing while considering both a global strategy and a local strategy to use, despite the failure of a node, the backup for this remains available.

In this more general manner, the invention can then also relate to a failure management method in a network of nodes, comprising, for each considered node of all or part of the nodes of the network performing the same calculation: first, a local backup step for this considered node on a storage medium for the considered node, where the link between this storage medium and this node can be redirected from this storage medium to another node. Then, if the considered node is failing, a local backup retrieving step for this considered node can be carried out, by redirecting the link between the considered node and its storage medium to connect the storage medium to an operational node that is different from the considered node, the local backups of these considered nodes used for the retrieving steps are coherent with each other to correspond to the same state of the calculation.

According to preferred versions, the invention comprises one or more of the following features which can be used separately, in partial combination with one another or in total combination with one another, applied to one or another of the objects of the invention mentioned above.

Preferably, during the scheduling of the new task by the network resource manager, the new task is assigned to nodes that are all the more robust to failures as this is a longer and more complex task.

Thus, the strategy of reassigning the nodes is improved because it is adapted according to the length and the complexity of the task. The scheduling of a new task allows this improvement by better adapting to the type of task considered

Preferably, during the scheduling of the new task by the network resource manager at least a portion of the non-failing nodes within the task where at least one node has become defective is replaced by new nodes with different properties to those they replace.

Thus, the strategy of reassigning the nodes is improved because it is better adapted and now able to use compute nodes that are better adapted but which were not available at the time the task was originally launched. The scheduling of a new task allows this improvement by better adapting to the type of task considered.

Preferably, the new nodes have different properties from those they replace and are more efficient, either individually or collectively as a group of nodes.

Therefore, the strategy of reassigning nodes is improved because it is more efficient and can now use more efficient compute nodes that were not available at the original launch of the task. Scheduling a new task allows this improvement by increasing performance

Preferably, the higher performance nodes are attached to computing accelerators while the nodes they replaced were not.

Thus, the new nodes assigned to the new task are significantly more efficient than the previous nodes. This makes enables such powerful nodes not to be left unused because all the tasks that need them are already running. Here, we take advantage of a failure to replace ordinary nodes with more efficient nodes, “killing two birds with one stone”.

Preferably, the new nodes become available after the beginning of the task during which at least one node has become defective.

Thus, one can use nodes that were not available at the launch of the task. Therefore, optimization is important here, because one can “recover” powerful nodes, even if these only become available during the execution of the task.

Preferably, the network resource manager detects the failure of a considered node by the loss of communication between this node and the netork resource manager.

Thus, no additional failure detection system needs to be put in place, the loss of communication between the failing node and the network resource manager is automatically detected during the execution of the current task.

Preferably, in this network of nodes, one or more additional calculations are performed in parallel with the calculation.

Thus, optimization can be further improved, insofar as any parallel computation that ends releases nodes that become available and which are eventually more efficient. These can be retrieved immediately and directly, in fact “on the fly”, by a calculation during execution that has suffered a failure at the precise time of the retrieving of this failure, here again, “killing two birds with one stone”.

Preferably, all the node relaunch steps are synchronized with each other, so as to relaunch all nodes in the same state of calculation.

This therefore ensures complete consistency for the rest of the calculation performed after the relaunch.

Preferably, for all or part of the nodes of the network performing the same calculation, the operational node and the failed node that it replaces belong to different calculation blades.

Thus, the redirection of the link between the support and the node can be performed even in the event of a major failure and even in a relatively generalized manner in terms of a whole computing blade.

Preferably, all these steps are performed for all the network nodes performing the same calculation.

Thus, the benefit of the failure management method proposed by the invention is generalized by extending to all nodes within the network performing the same calculation.

Preferably, the redirection of the link between the node in question and its storage medium in order to connect the storage medium to the operational node is achieved by a change of routing through a switch connecting several nodes to their storage media.

So, this redirection is performed by a simple operation performed by a network element that is reliable and controlled.

Preferably, the retrieving step changes the attachment of the local backup storage medium from the failed node through a switch attached to the failed node and its local backup storage medium, but without going through the failed node itself.

So, the redirection can be performed even if there is a complete physical failure of the failing node.

Preferably, the change of attachment is achieved by sending a command to the switch, this command passing through one of the nodes attached to the switch by means of a management port.

Thus, the management port or management is assigned to retrieve the storage media of the failed nodes attached to the same switch.

Preferably, this switch is a PCIe switch (Peripheral Component Interconnect express).

Thus, this switch is particularly advantageous because it is particularly suited to allow devices to communicate with each other without having to go through a microprocessor. This means failing computing node can be bypassed, for example.

The use of this PCIe switch allows the storage medium, for example a storage disk containing the local backups of the failed computing node to be reattached to another computing node. This operation is fast and does not require a systematic copy of the local backup data and, in particular, not for non-failing compute nodes.

Preferably, 3 to 10 nodes are attached to the same switch.

Thus, the switch can easily manage this small group of nodes in the event of a failure of a node in this small group.

Preferably, the failure management method also includes, for all or part of the nodes of the network performing the same calculation and even if no considered node fails, a global backup step for all these nodes, performed less frequently than all the local backup steps for these nodes.

Thus, on the one hand, the local-intermediate backup offered by the invention to manage the vast majority of failures in a simple and efficient manner, and on the other hand the global backup, which is more complex and more expensive but reserved for a minority of severe failures, are excellent compromise between the overall complexity and overall efficiency of the failure management method proposed by the invention.

In the context of a failure-tolerant application, using multiple backup levels as here, with a fast local backup and a more complex and expensive remote global backup, the failure management method proposed by the invention then allows the application to restart, following a physical failure on a node, even if this is a complete failure, and in most cases, starting from all the local backups, which are more recent and less expensive, instead of having to restart from remote backups that are often significantly older. However, some rarer failure cases can require the use of a remote global backup. The ability to retrieve local data from the failed compute node allows you to restart the application from most recent local backups in most cases.

Preferably, for all or part of the nodes of the network performing the same calculation, the network does not include any spare node for the nodes performing the same calculation.

Thus, the utilization rate of the network nodes is easier to maximize, insofar as no compute node is blocked during a significant specified duration while remaining associated with a calculation in progress, without being used in this calculation simply to serve as a spare node in case of a failure occurring in this calculation in progress. Indeed, either the number of spare nodes that could be blocked remains limited and the unlucky occurrence of several successive failures causes a loss of the calculation, possibly a considerable loss, or the number of spare nodes that could be blocked in this way becomes important to address, even the worst case of successive failures. This is where there is a rate of blocked unused spare nodes that will be detrimental to the overall profitability of the network of computing nodes.

Preferably, for all or part of the nodes of the network performing the same calculation, the storage media are flash memories.

Thus, the memories used are simple, fast and permanent.

Preferably, these flash memories are NVMe memories (Non-Volatile Memory express).

Thus, the memories used are particularly well suited to communicate with a PCIe switch (Peripheral Component Interconnect express).

Preferably, the network of compute nodes comprises at least 1000 compute nodes, ideally at least 5000 compute nodes, better still, at least 10000 compute nodes, making the failure management method according to the invention all the more important because the complete loss of a current calculation then becomes all the more critical due to the large network.

The principle of failure tolerance is all the more important when an application runs on a cluster that consists of a larger number of compute nodes. The greater the number of processors, memory and other devices, the greater the probability that a failure will occur before the end of the execution process. Applications that aim to run on this type of platform will use failure tolerance libraries that allow them to saveguard (checkpoint) the data needed for a restart in a state as close as possible to the state that existed just before the failure. Thus, these applications are not forced to restart the calculation from the beginning.

Other features and advantages of the invention will become evident upon reading the following description of a preferred version of the invention given with an example and reference made to the accompanying drawings.

### BRIEF DESCRIPTION OF THE DRAWINGS

FIG. 1 diagrammatically represents an example of a network part including a group of nodes and their storage media connected to each other by a PCIe switch, according to one version of the invention for a part of the network where an example of a failure management method can take place according to the invention.

FIG. 2 diagrammatically represents an example of the progress of a local backup step during the failure management method, according to one version of the invention.

FIG. 3 schematically represents an example of the occurrence of a failure, causing a failing node during the failure management method according to one version of the invention.

FIG. 4 diagrammatically represents an example of the progress of a step for recovering the local backup of a failing node during the failure management method, according to one version of the invention.

FIG. 5 diagrammatically represents an example of the progress of a step of returning local backups for a global backup during the failure management method, according to one version of the invention.

FIG. 6 diagrammatically represents an example of the progress of a operational step for the global backup to relaunch a new calculation task during the failure management method, according to one version of the invention.

### DETAILED DESCRIPTION OF THE INVENTION

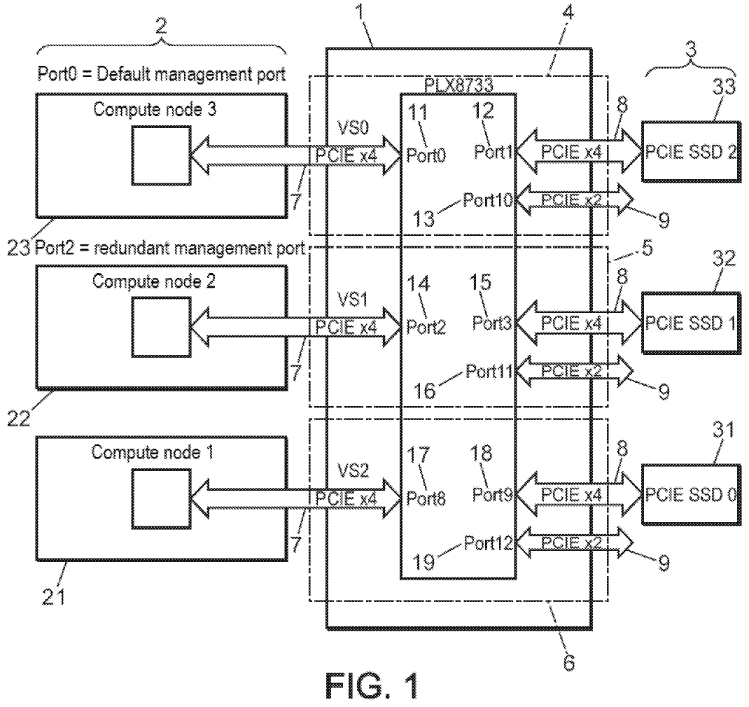

FIG. 1 diagrammatically represents an example of a part of the network, including a group of nodes and their storage media connected to each other by a PCIe switch, according to one version of the invention, at the part of the network where an example of a failure management method can take place according to the invention.

This part of the network comprises several compute nodes 2, three compute nodes 21, 22 and 23 in the example in FIG. 1, as well as several storage supports 3, three storage media 31, 32 and 33 in the example in FIG. 1.

These compute nodes 2 and their storage media 3 form a group of compute nodes managed by a PCIe switch 1 connecting these compute nodes 2 to their respective storage media 3 via PCIe bidirectional connections 7, 8 or 9. These PCIe connections 7, 8, or 9 may be PCIe multi-way connections. The connection 7 is a 4-way connection. The connection 8 is a 4-way connection. The connection 9 is a 2-way connection, not yet used here, each connection 9 attached on one side to one of the ports 13, 16 or 19 and remaining free on the other side. Each PCIe connection 7 respectively connects one of the compute nodes 21 to 23 to one of the ports 0, 2 or 8 (numbering of the electronic switch PLX 8733, but another PCIe switch can be used), respectively referenced 11, 14 or 17 in FIG. 1 of switch 1. Each PCIe connection 8 respectively connects one of the storage media 31 to 33 to one of the ports 1, 3 or 9, respectively referenced 12, 15 or 18 in FIG. 1 of switch 1. The connection 7, the ports 0 and 1, respectively referenced 11 and 12 in FIG. 1 of switch 1 and connection 8 together form a link 4 connecting the compute node 23 to its support 33. The connection 7, the ports 2 and 3, respectively referenced 14 and 15 in FIG. 1 of switch 1 and the connection 8 together form a link 5 connecting the compute node 22 to its support 32. The connection 7, the ports 8 and 9, respectively referenced 17 and 18 in FIG. 1 of switch 1 and the connection 8 together form a link 6 connecting the compute node 21 to its support 31. PCIe 7, 8, or 9 connections can be grouped on a PCIe bus.

The compute node 23 is attached to the management port or default management, i.e., it is through this that the consignments transit towards the exterior of the group of compute nodes 2 and receptions from the exterior of the compute node group 2. In the event of failure of compute node 23, this is replaced by compute node 22, which is attached to the management port or redundant management and compute node 22 then becomes attached to the new management port or effective management.

When a compute node fails physically, for example, compute node 21 or compute node 22, we will consider here the compute node 21, the last recent local backup of its computation state is stored on its storage medium 31.

In a system based on a previous method, the storage medium 31 being accessible only by its computing node 21 and the latter being in complete physical breakdown, this recent local backup would become inaccessible. Then, it would be necessary to resort to other more complex and less recent backup levels, resulting in a significant loss of overall efficiency for the computer network.

In the system according to one version of the invention, shown in FIG. 1, storage medium 31's attachment is reconfigured, i.e., the storage medium 31 will cease to be connected to its compute node 21, to which it is attached by default, but will become connected to computing node 23, which is attached to the default management port and will be able to trace the local backup for the calculation of the failed computing node 21, since the storage medium 31 is linked to another spare computing node outside of the group of compute nodes 21 to 23, this other compute node then taking over the calculation task interrupted at the failed computing node 21 from the local backup of the computing state of compute node 21, sent from storage medium 31 during a new task scheduled by the resource manager.

In switch 1, (numbering of the electronic switch PLX8733, but another PCIe switch can be used) referenced 18 (in FIG. 1), instead of remaining permanently connected to port 8 referenced 17 as before the failure of computing node 21, port 9 will be, at least temporarily, connected to port 0 referenced 11 to allow compute node 23 to read from the storage medium 31 the saved data representative of the calculation state of calculation node 21 just before or shortly before its failure. Thus, the local backup of the calculation state of the compute node 21 in storage medium 31 before its failure, will be able to go back to computing node 23 and be used to relaunch the calculation with a very good compromise between simplicity of the backup and efficiency of the retrieving.

If node 23 becomes failing, it is first replaced by compute node 22 as attached to the management port and compute node 22, as attached to the new management port, performs the operations previously performed by computing node 23 had it not become defective.

The management of switch 1 is now described by a manual scenario clarifying and explaining the various operations to be performed, such as, for example, the migration of storage medium 31 from a failing compute node 21 to a spare compute node 23, the transfer of data and restarting the application. Data management on the application side is performed by the FTI library.

The executed application is provided in examples of the FTI library: hdf.exe. This application is launched on two compute nodes. It will perform local backups on NVMe storage disks attached to these compute nodes by the PCIe switch at regular intervals as well as a global backup on a NFS server (Network File System) less frequently. Once the application is launched, a failure is generated on one of the two compute nodes. The migration of the NVMe storage disk from the failed node to another node will then allow the transfer of data from the last local backup of that failed node to another node. Once this transfer is made, the application can be relaunched and resumes the calculation using the last local backup of the two compute nodes instead of the last older global backup of the network part.

In this context, a failure retrieving is performed with the local backup data of an MPI application (Message Passing Interface) of a failing computing node. The data is retrieved by migrating the storage medium from the failed compute node to a compute node adjacent to the same compute blade. This data is then transmitted to a second operational node, which will resume the calculation. The advantage of this failure retrieving is that it allows the application to restart from local backups of all compute nodes. These less expensive local backups are also newer most of the time and, at worst, are as recent as global backups.

In the following development, the text in a box or in brackets concerns lines of computer code.

The Fault Tolerance Interface (FTI) library will use, in particular, four existing main functions and four existing complementary functions.

The four main functions are “FTI_Init”, “FTI_Finalize”, “FTI_Protect”, “FTI-Snapshot”, more precisely:

int FTI_Init (char* configFile, MPI_Comm globalComm)

“FTI_Init” reads a “configFile” configuration file, creates control point directories, detects the system topology, initializes the FTI communicator using “globalComm” and regenerates the data after retrieving. This function returns “FTI_SCES” on success or “FTI_NSCS” on failure. This function should be called upon before the other FTI functions, just after the MPI (Message Passing Interface) initialization.

### int FTI_Finalize( )

“FTI_Finalize” frees allocated memory, completed completion, and cleans checkpoints and metadata. This function returns “FTI_SCES” for an application process or “exit (0)” for a header process. This function should be called upon before “MPI_Finalize( )”.

int FTI_Protect (int id, void* ptr, long count, FTIT_type type)

“FTI_Protect” stores metadata about the variable to be protected. Each protected variable is identified by “id”. Its address “ptr”, the calculation of the number and the type of element to save this variable can be changed during the execution.

### int FTI_Snapshot( )

“FTI_Snapshot” loads the checkpoint data and initializes the runtime variables after retrieving and writes the multilevel checkpoints according to their required frequencies.

The four additional functions are “FTI_Checkpoint”, “FTI_Recover”, “FTI_InitType”, “FTI_Status”.

The function “FTI_Snapshot ( )” can be replaced by the function “FTI_Checkpoint” and by the function “FTI_Recover”.

More precisely:

int FTI_Checkpoint (int id, int level)

“FTI_Checkpoint” writes the values of the protected execution variable “id” to a required level checkpoint file.

### int FTI_Recover( )

“FTI_Recover” loads the checkpoint data from the checkpoint file and initializes the runtime variables.

int FTI_InitType(FTIT_type* type, int size)

“FTI_InitType” initializes a new data type called “type” and its size is a size in bytes.

### int FTI_Status( )

“FTI_Status” returns the current state of the retrieving flag. This state can be “0” if no control point has been successfully completed or retrieved, “1” if at least one control point has been completed, or “2” if the execution has been relaunched from an L4 checkpoint and if “keep_last_checkpoint” was enabled during the last run.

To provide a failure-resilient process using the hardware and failure-tolerant software described in this patent application, it is interesting to develop some improvements in the “Simple Linux Utility for Resource Management” (SLURM), especially the “checkpoint-restart” option, and the “SLURM_JOB_NODES_DOWN” and “SLURM_RESTART_COUNT” variables.

The “checkpoint-restart” option is added for the “sbatch” function. If installed, a flag in the task record is installed to inform the SLURM controller to allocate nodes based on the layout of the PCIe switches defined in the “switch.conf file”. This file can be generated using a script generator presented in Annex 1 at the end of the description. An example of such an implementation of this file is now shown here:

Priority=10
Root=Cluster
#Root level Layout configuration
Entity=Cluster Type=Center Enclosed=pci[0-1]
#Switch level Layout configuration
Entity=pci0 Type=Switch NodeList=trek[0-1,4]
Enclosed=trek[0-1,4]
Entity=pci1 Type=Switch NodeList=trek[5-7]
Enclosed=trek[5-7]
#Node level Layout configuration
Entity=trek0 Type=Node Role=Manager PCISwitch=pci0
Entity=trek1 Type=Node Role=Backup PCISwitch=pci0
Entity=trek4 Type=Node Role=Other PCISwitch=pci0
Entity=trek5 Type=Node Role=Manager PCISwitch=pci1
Entity=trek6 Type=Node Role=Other PCISwitch=pci1
Entity=trek7 Type=Node Role=Backup PCISwitch=pci1

“Sbatch” recognizes this new command line option and installs an “opt.ckpt_restart=1” internal flag. This option can also be provided to “sbatch” via the input environment variable “SBATCH_CHECKPOINT_RESTART”. This option is copied to the “job_desc_msg_t” structure which will then be copied to the “job_record” structure in the controller. In the controller, it can be referenced via “job_ptr->ckpt_restart”. Some environment variables that are added to the prolog and epilog environments will only be installed when the “--checkpoint-restart” command line flag is installed.

A new variable “SLURM_JOB_NODES_DOWN” is added. It contains a list of allocated nodes that failed during the execution of the task. By default, only the first node to become failing will be listed. If the “--no-kill (-k)” option is specified, then all nodes that have become defective are listed. It is installed by the controller in the process that deletes the tasks. Each node can access it.

The variable “SLURM_RESTART_COUNT” is modified to be propagated as an environment variable for all SLURM epilogues. The structure “job_ptr->restart_cnt” will only be incremented by the “SBATCH” tasks.

These two environment variables and their values will pass from the controller to the compute nodes via a “Remote Procedure Call” (RPC) message that will extract them and transfer them to a local structure “job_env”, which is used to install the environment variables in the prologue and epilogue environments.

In a first step, the user will at least code the functions “FTI_Init”, “FTI_Protect”, “FTI_Snapshot” and “FTI_Finalize”. Then, he will replace “MPI_COMM_WORLD” with “FTI_COMM_WORLD”, and adapt the parameters in the FTI configuration file. Then, the user can use the classic “sbatch” script with an additional option “#SBATCH --checkpoint-restart”.

In a second step, as far as possible, SLURM allocates three nodes per blade to the task or at least the management and replacement manager nodes of the PCIe switch.

In a third step, during the SLURM prolog, the switch configuration and the mount point are checked. “SLURM_RESTART_COUNT is initialized.

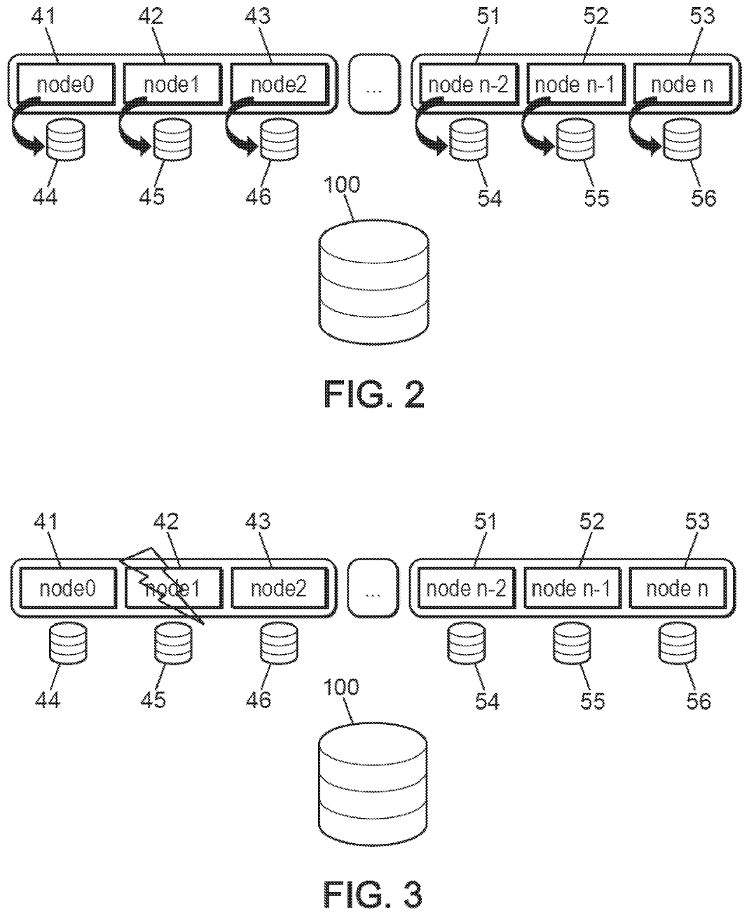

FIG. 2 diagrammatically represents an example of the progress of a local backup step during the failure management method according to one version of the invention.

In a fourth step, SLURM launches the MPI ranks. FTI writes the files for the control point with a frequency specified by the user.

Nodes 41 to 43 are respectively associated with storage media 44 to 46. Nodes 41 to 43 belong to the same computing blade. Nodes 51 to 53 are respectively associated with storage media 54 to 56. Nodes 51 to 53 belong to the same calculation blade, which is different from that for nodes 41 to 43. The storage media 44 to 46 and 54 to 56 provide local backups of the state of their respective associated nodes 41 to 43 and 51 to 53, while a parallel file system 100 provides a global backup of the state of the data network nodes or at least part of the network. The parallel file system 100 is a network file system.

Periodically, ideally with a duration of between 1 and 20 minutes, better still with a duration of between 2 and 10 minutes, for example every 2, 5 or 10 minutes, the storage supports 44 to 46 and 54 to 56 ensure a local backup of the state of their associated respective nodes 41 to 43 and 51 to 53.

FIG. 3 schematically represents an example of a failure occurrence, rendering a node failing, during the failure management method, according to one version of the invention.

In a fifth step, the SLURM detects the failure of a node and launches the epilogue that contains the update of “SLURM_JOB_DOWN_NODELIST” with the list of failed nodes, the update of “SLURM_RESTART_COUNT”, and the retrieving system.

A node, for example, node 42 suffers a failure (symbolized by a small flash in FIG. 3). The other nodes 41 and 43 of this same calculation blade are not failing. Nodes 51 to 53 of the other calculation blade are not defective either.

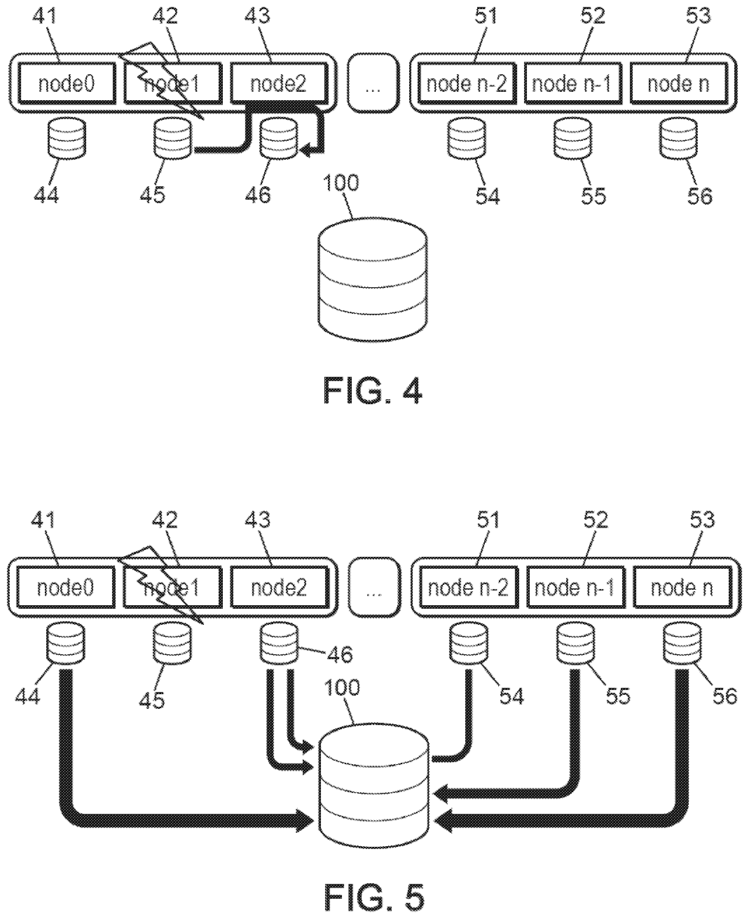

The retrieving system launched during the epilogue is separated into two parts, respectively described in FIGS. 4 and 5, during the first and second parts of a sixth step.

FIG. 4 diagrammatically represents an example of the progression of a retrieving step for the local backup of a failing node during the failure management method according to one version of the invention.

In the first part of the sixth stage of the retrieving system, the configuration of the PCIe switch is changed and the checkpoint files are retrieved.

The local backup of the state of the failed node 42, performed on storage medium 45, is duplicated on storage medium 46 of the non-failing node 43, via the PCIE switch of the calculation blade and via the non-failing node 43.

FIG. 5 diagrammatically represents an example of the progression of a step for returning local backups to a global backup during the failure management method, according to one version of the invention.

In the second part of the sixth step of the retrieving system, all checkpoint files are sent to the parallel file system (“Parallel File System”).

Storage media 44 and 54 to 56 transmit the local backups for the non-failing nodes 41 and 51 to 53 to the parallel file system 100 to perform the global network backup or at least for that part of the network. Still as part of performing this global backup, storage medium 46 transmits to the parallel file system 100 not only the local backup of the state of its non-failing associated node 43 but also the duplication of the local backup of the state of the failed node 42. So, the parallel file system 100 can store the global backup for the state of the nodes 41 to 43 and 51 to 53, coherently with each other and corresponding to the same state of calculation from where a new task using this same calculation can later be relaunched.

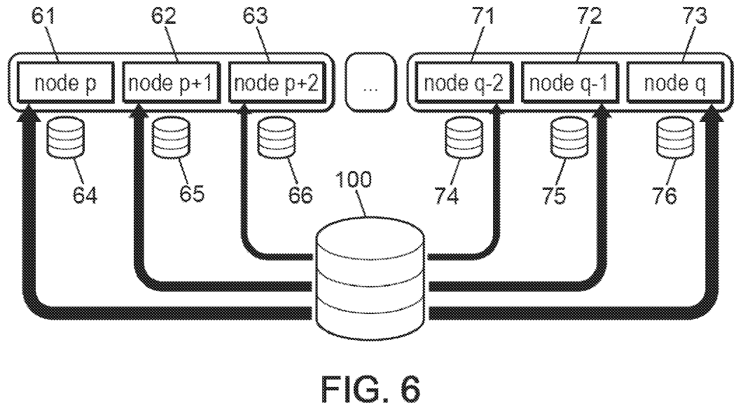

FIG. 6 diagrammatically represents an example of the progress of a step of operating the global backup to relaunch a new calculation task during the failure management method, according to one embodiment of the invention.

In a seventh step, a new task is resubmitted on a new node allocation to perform the desired calculation. The application is restarted. FTI loads the data from the checkpoint files. The calculation can be resumed and continued from the last state saved coherently between the different nodes. The failure-resilient process resumes at the fourth step shown in FIG. 2 until a new failure occurs or until the running calculation is completed.

The parallel file system 100 transmits a compute blade to a new compute blade, comprising the computing nodes 61 to 63 respectively associated with the storage media 64 to 66, and another computing blade comprising the computing nodes 71 to 73 respectively associated with the storage media 74 to 76, the local backups of the states of nodes 41 to 43 and 71 to 73, allowing these nodes 61 to 63 and 71 to 73 to resume the current calculation from a state corresponding to recent local backups consistent with each other and stored in a global backup in the parallel file system 100.

The course of an experiment will now be described.

The task is submitted with a script “sbatch” with the option “#SBATCH --checkpoint-restart”.

The application, as modified according to Annex 1, is launched on nodes [10049-10050].

#!/bin/bash
#SBATCH --job-name test-FT
#SBATCH --time 60:00
#SBATCH --nodes 2
#SBATCH --output test-FT_%j.out
#SBATCH --ntasks 40
#SBATCH --nodelist pluton[10049,10050]
#SBATCH --ntasks-per-node=20
#SBATCH --checkpoint-restart
srun -n 40 $HOME/POC_pluton/hd.exe 40 config.fti

As shown on the output below, FTI creates a new “ID” run that is initialized. Three variables are protected (ID 0, 1 and 2). Each checkpoint file is 40 MB in size. More than 1500 iterations are performed and 5 control points are created before the occurrence of a simulated failure.

[FTI Information]: Reading FTI configurations file
(config.fti)...
[FTI Information]: The execution ID is: 2017-09-
05_16-23-20
[FTI Information]: FTI has been initialized.
Local data size is 10240 x 259 = 40.000000 MB (40).
Target precision: 0.005000
Maximum number of iterations: 5000
[FTI Information]: Variable ID 0 to protect. size
per rank is 0.00MB.
[FTI Information]: Variable ID 1 to protect. size
per rank is 20.23MB.
[FTI Information]: Variable ID 2 to protect. size
per rank is 40.47MB.
Step: 0, error = 1.000000
[FTI Information]: Post-checkpoint took 1.01 sec.
(Ag:1.01s, Pt:0.00s, Cl:0.00s)
[FTI Information]: Ckpt. ID 1 (L1) (40.47 MB/proc)
taken in 1.98 sec.
Step: 500, error = 0.048781
[FTI Information]: Post-checkpoint took 1.76 sec.
(Ag:0.26s, Pt:0.00s, Cl:1.50s)
[FTI Information]: Ckpt. ID 2 (L1) (40.47 MB/proc)
taken in 3.13 sec.
[FTI Information]: Post-checkpoint took 2.43 sec.
(Ag:0.95s, Pt:0.00s, Cl:1.48s)
[FTI Information]: Ckpt. ID 3 (L1) (40.47 MB/proc)
taken in 3.46 sec.
Step: 1000, error = 0.024291
[FTI Information]: Post-checkpoint took 1.48 sec.
(Ag:0.00s, Pt:0.00s, Cl:1.48s)
[FTI Information]: Ckpt. ID 4 (L1) (40.47 MB/proc)
taken in 3.14 sec.
Step: 1500, error = 0.016173
[FTI Information]: Post-checkpoint took 1.86 sec.
(Ag:0.15s, Pt:0.00s, Cl:1.71s)
[FTI Information]: Ckpt. ID 5 (L1) (40.47 MB/proc)
taken in 3.69 sec.
srun: Job step aborted.

SLURM detected the pluton node failure 10049. The pluton node 10050 is the PCIe switch manager node. It changes the configuration of the PCIe switch, duplicates the checkpoint files stored on the NVMe disk of the pluton node 10049, and transfers the pluton node control point files [10049-10050] to the parallel file system. This process uses a script presented in Annex 1.

The task is scheduled again but on a new allocation pluto [10048,10050].

As shown below, FTI detects that the application is successfully relaunched and retrieves the checkpoint data stored in the parallel file system. The calculation is relaunched from the last saved calculation state, iterations are carried out and checks are carried out until the calculation is completed (error <0.005).

[FTI Information]: Reading FTI configurations file
(config.fti)...
[FTI Information]: This is a restart. The execution
ID is: 2017-09-05_16-23-20
[FTI Information]: No possible to restart from
level 1.
[FTI Information]: No possible to restart from
level 2.
[FTI Information]: No possible to restart from
level 3.
[FTI Information]: Recovering successfully from
level 4.
[FTI Information]: FTI has been initialized.
Target precision: 0.005000
Maximum number of iterations: 5000
[FTI Information]: Post-checkpoint took 1.49 sec.
(Ag:0.00s, Pt:0.00s, Cl:1.49s)
[FTI Information]: Ckpt. ID 6 (L1) (40.47 MB/proc)
taken in 3.14 sec.
Step: 2000, error = 0.012121
[...lot of iterations and some checkpoints...]
Step: 4500, error = 0.005382
[FTI Information]: Post-checkpoint took 1.61 sec.
(Ag:0.12s, Pt:0.00s, Cl:1.48s)
[FTI Information]: Ckpt. ID 15 (L1) (40.47 MB/proc)
taken in 3.47 sec.
Execution finished in 1980.580462 seconds.
[FTI Information]: FTI has been finalized.

Of course, this invention is not limited to the examples and the versions described and shown, but it is capable of numerous variants accessible to those skilled in the art.

### Annex 1: Computer Listing Used in the Progress of the Previously Described Failure Management Method

### For the “Disposition/Generation Configuration Switch”

(“Layout.d/switch.conf.generator”)

```
linestart=“Priority=10\nRoot=Cluster\n\n#Root level
Layout configuration\nEntity=Cluster Type=Center
Enclosed=”
linepci=“\n\n#Switch level Layout configuration”
linenode=“\n\n#Node level Layout configuration”
while true; do
    first=\grave{ }nodeset -e $nodes | awk ‘{print $1;}’\grave{ }
    bmc=bmc${first##[a-z]*[a-z]}
    radical=\grave{ }echo $first | sed -e ‘s/[0-9]*$//’\grave{ }
    unset pci
    for line in \grave{ }$ssh pmsmModel.py display -n $bmc
--neighbour --csv --column NAME LOCATION --no-
header\grave{ }; do
        if [[ $line = “Error” ]]; then
            echo “error: $first and its bmc $bmc
not found by pmsmModel.py”
                  exit 3
        fi
        location=\grave{ }echo $line | cut -d “,” -f2\grave{ }
        name=\grave{ }echo $line | cut -d “,” -f1\grave{ }
        current=$radical\grave{ }echo $name | sed -e
“s/.*\[bmc//g”| sed -e “s/\]//g”\grave{ }
        end=${location: −2}
        begin=${location::−2}
        if [ \grave{ }nodeset -c $nodes -i $current\grave{ } = 0
]; then
            continue
        fi
        if [[ ! -v pci ]]; then
            pci=$begin
            liste=$current
        else
            if [ “Spci” = “$begin” ]; then
                  liste=“$liste,$current”
            else
                  echo “error: $pci and $begin
set in same neighbourhood for $bmc”
                  exit 3
            fi
        fi
            if [[ $end = “Rp” ]]; then
                    role=“Manager”
            elif [[ $end = “Mp” ]]; then
                    role=“Backup”
            elif [[ $end = “Lp” ]]; then
                    role=“Other”
            else
            echo “error: $current has an
unknown position on $pci: $end”
                      exit 3
        fi
        linenode=“$linenode\nEntity=$current
Type=Node Role=$role PCISwitch=$pci”
    done
    if [ \grave{ }nodeset -c $liste -i $first\grave{ } = 0 ]; then
        echo “error: $first and its bmc $bmc not
really found in $pci”
            exit 3
    fi
    if [[ ! -v listepci ]]; then
        listepci=$pci
    else
        listepci=“$listepci,$pci”
    fi
    liste=\grave{ }nodeset -f $liste\grave{ }
      linepci=“$linepci\nEntity=$pci Type=Switch
NodeList=$liste Enclosed=$liste”
    if [ \grave{ }nodeset -c $nodes -x $liste\grave{ } = 0 ]; then
        break;
    fi
    nodes=\grave{ }nodeset -f $nodes -x $liste\grave{ }
done
listepci=\grave{ }nodeset -f $listepci\grave{ }
total=“$linestart$listepci$linepci$linenode”
if [[ -v output ]]; then
    echo -e $total > $output
else
    echo -e $total
fi
exit 0
```

### Example of Modification to Use the FTI Library

```
int main(int argc, char *argv[ ])
{
    int rank, nbProcs, nbLines, i, M, arg;
    double wtime, *h, *g, memSize, localerror,
globalerror = 1;
    MPI_Init(&argc, &argv);
    FTI_Init(argv[2], MPI_COMM_WORLD);
    MPI_Comm_size(FTI_COMM_WORLD, &nbProcs);
    MPI_Comm_rank(FTI_COMM_WORLD, &rank);
    M = (int)sqrt((double)(arg * 1024.0 * 512.0 *
nbProcs)/sizeof(double));
    nbLines = (M / nbProcs)+3;
    h = (double *) malloc(sizeof(double *) * M *
nbLines);
    g = (double *) malloc(sizeof(double *) * M *
nbLines);
    initData(nbLines, M, rank, g);
    memSize = M * nbLines * 2 * sizeof(double) /
(1024 * 1024);
    FTI_Protect(0, &i, 1, FTI_INTG);
    FTI_Protect(1, h, M*nbLines, FTI_DBLE);
    FTI_Protect(2, g, M*nbLines, FTI_DBLE);
    wtime = MPI_Wtime( );
    for (i = 0; i < ITER_TIMES; i++) {
      int checkpointed = FTI_Snapshot( );
      localerror = doWork(nbProcs, rank, M,
nbLines, g, h);
      if (((i%ITER_OUT) == 0) && (rank == 0)) {
        printf(“Step : %d, error = %f\n”, i,
globalerror);
      }
      if ((i%REDUCE) == 0) {
        MPI_Allreduce(&localerror, &globalerror, 1,
MPI_DOUBLE, MPI_MAX,
                    FTI_COMM_WORLD);
        }
        if(globalerror < PRECISION) {
            break;
        }
    }
    if (rank == 0) {
        printf(“Execution finished in %lf
seconds.\n”, MPI_Wtime( ) - wtime);
    }
    free (h);
    free (g);
    FTI_Finalize( );
    MPI_Finalize( );
    return 0;
}
```

### For the Part: “NVMe Disk Detection Control and Installation Point”

```
#!/usr/bin/bash
# Copyright (C) Christophe Laferriere 2017 Bull S.
A. S. - All rights reserved
# Bull, Rue Jean Jaures, B.P.68, 78340, Les Clayes-
sous-Bois
# This is not Free or Open Source software. Please
contact Bull S. A. S. for
# details about its license.
# This script checks that an NVMe disk is mounted
in a given location
# Default hardcoded location for mountpoint
FTI_CKPT_LOCATION=“/localckpt”
# Where is mounted the NVMe disk :
NVME_MOUNT_LOCATION=\grave{ }mount | grep nvme | cut -d ‘ ’
−f 3\grave{ }
# If no NVMe disk is mounted, exit with error code
:
[[ -z $NVME_MOUNT_LOCATION ]] && echo “Error: No
NVMe disk mounted” && exit 1
# Finally check if NVMe is mounted in the right
place :
if [[ $FTI_CKPT_LOCATION == $NVME_MOUNT_LOCATION*
]] ;
then
  exit 0
else
  echo “Error: NVMe disk is not mounted where it
should be ($FTI_CKPT_LOCATION vs
$NVME_MOUNT_LOCATION)”
  exit 1
fi
```

for the part: “backup retrieving”, the script is running on the root of the PCIe switch manager node

#!/bin/bash
EXECID=$1
MANAGER=$2 #10050
CRASHEDNODE=$3 # 2 <=> pluton10049
#PCIe switch reconfiguration
bpsm_grab_port 3
ipmitool -H bmc${MANAGER} raw 0x3a 0xcd
${CRASHEDNODE}
echo 1 > /sys/bus/pci/devices/0000:00:00.0/rescan
#Checkpoint retrieving and flush
mkdir /localretrieving ; mount /dev/nvme1n1
/localretrieving
cp -r /localretrieving/${EXECID}
/scratch/globalckpt/
mv /scratch/globalckpt/${EXECID}/l1
/scratch/globalckpt/${EXECID}/l4
cp /localckpt/${EXECID}/l1/*
/scratch/globalckpt/${EXECID}/l4/
mv /scratch/meta/${EXECID}/l1
/scratch/meta/${EXECID}/l4

1. A failure management method in a nodes network (21-73), comprising, for each node considered (21-53) of all or part of the nodes (21-73) of the network performing a same calculation:
firstly, a step for locally backing up the state of this considered node (21-53), to a storage medium (31-56) for this considered node (21-53), the link between this storage medium (31-56) and this considered node (21-53) can be redirected from this storage medium (31-56) to another node (21-73),
then, if the considered node has failed (21, 42), a step for retrieving the local backup of the state of this considered node (21, 42) by redirecting the link between the considered node (21, 42) and its storage medium (22, 45) for connecting this storage medium (22, 45) to an operational node (23, 43) that is different from the considered node (21, 42),
the local backups of these considered nodes (21-53) used for the retrieving steps are coherent with one another so as to correspond to the same state of this calculation.

2. A failure management method in a nodes network (21-73), including, for each considered node, (21-53) in full or in part for the nodes (21-73) of the network performing a same calculation:
firstly, a step of locally backing up the state of this considered node (21-53), to a storage medium (31-56) for this considered node (21-53), the link between this storage medium (31-56) and this considered node (21-53) can then be redirected from this storage medium to another node (21-73),
then, if the considered node has failed (21, 42), a step to retrieve the local backup of the state of this considered node (21, 42) by redirecting the link between the considered node (21, 42) and its storage medium (31,45) to connect the storage medium (31,45) to a different operational node (23,43) for the considered node (21,42), this operational node (23,43) already being performing this calculation,
the local backups of these considered nodes (21-53) used for the retrieving steps, are coherent with one another so as to correspond to the same state of this calculation,
then, if at least one considered node has failed (21, 42), a step to return said local backups to a global backup within a network file system.

3. A failure management method according to claim 2, further comprising:
after the return step, a step to relaunch the calculation from the global backup integrating the local backups during the scheduling by the network resource manager of a new task using all or part of the nodes (21-53) having already participated in said calculation and/or nodes (61-73) that have not yet participated in the calculation.

4. A failure management method according to claim 3, wherein, during the scheduling of the new task by said network resource manager, said new task is assigned to nodes (61-73) all the more robust to failures as this is a longer and more complex task.

5. A failure management method according to claim 3, wherein, during the scheduling of said new task, by the network resource manager, at least a part of the non failing nodes (51-53) of the task in which at least one node has started to fail (42) is replaced by new nodes (71-73) that have different properties to those they replace.

6. A failure management method according to claim 5, wherein the new nodes (71-73) with different properties to those they replace are nodes (71-73) that are more performing than those they replace, either individually or collectively within a group of nodes.

7. A failure management method according to claim 6, wherein the higher performance nodes (714-73) are attached to computing accelerators while the replaced nodes (51-53) are not.

8. A failure management method according to claim 3, wherein the new nodes (71-73) have become available after the beginning of the task in which at least one node (42) has started to fail.

9. A failure management method according to claim 3, wherein the network resource manager detects the failure of a considered node (42) by the loss of communication between this node (42) and the network resource manager.

10. A failure management method according to claim 1, wherein, within the network of nodes (21-73), one or more other calculations are performed in parallel with said calculation.

11. A failure management method according to claim 3, wherein all the steps for relaunching nodes are synchronized with one another, so as to relaunch all these nodes (61-73) in the same calculation state.

12. A failure management method in a network of nodes, according to claim 1, claim 1, for all or part of the nodes (21-53) of the network performing a same calculation, the operational node (62) and the failing node (42) that it replaces belong to different computing blades.

13. A failure management method according to claim 1, wherein all these steps are performed for all the nodes (21-53) in the network performing a same calculation.

14. A failure management method according to claim 1, wherein said redirection of the link between the considered node (21-53) and its storage medium (31-56) to connect the storage medium (31-56) to said operating node (21-53) is performed by a switching change in a switch (1) connecting several nodes (21-23) to their storage media (31-33).

15. A failure management method according to claim 1, wherein the retrieving step changes the attachment of the storage medium (31, 45) of the local backup of the state of the failing node (21, 42) via a switch (1) to which the failing node (21, 42) and its storage medium (31, 45) of the local backup of the failing node (21, 42) were attached, but without passing through the failing node (21, 42) itself.

16. A fault management method according to claim 15, wherein the change of attachment is achieved by sending a command to the switch (1), this command passing through one of the nodes (22, 23) attached to the switch (1) by a management port (11, 14).

17. A failure management method according to claim 14, wherein this switch (1) is a PCIe switch.

18. A failure management method according to claim 14, wherein 3 to 10 nodes (21-53) are attached to the same switch (1).

19. A failure management method according to claim 1, further comprising, for all or part of the nodes (21-53) of the network performing a same calculation, even if no considered node fails, a global backup step for all these nodes (21-53), performed less often than all the local backup steps for these nodes (21-53).

20. A failure management method according to claim 1, wherein, for all or part of the nodes (21-53) in the network performing a same calculation, the network does not include any node to replace nodes (21-53) performing said same calculation.

21. A failure management method according to claim 1, wherein, for all or part of the nodes (21-53) of the network performing a same calculation, the storage media (31-56) are flash memories.

22. A failure management method according to claim 21, wherein these flash memories are NVMe memories.
